(19) United States
(12) Patent Application Publication
(10) Pub. No.: US 2013/0265456 A1
(43) Pub. Date: Oct. 10, 2013

(54) METHOD AND APPARATUS FOR CONTROLLING OPERATION MODE OF MEDIA DEVICE

(71) Applicant: SAMSUNG ELECTRONICS CO. LTD., Suwon-si (KR)

(72) Inventors: Sie-Joon CHO, Seoul (KR); Suck-Ho SEO, Suwon-si (KR); Ki-Suh AHN, Seoul (KR); Hye-Jung YANG, Busan (KR); Kyung-Soo LIM, Hwaseong-si (KR); Eun-Hee RHIM, Yongin-si (KR)

(73) Assignee: Samsung Electronics Co. Ltd., Suwon-si (KR)

(21) Appl. No.: 13/856,030

(22) Filed: Apr. 3, 2013

(30) Foreign Application Priority Data
Apr. 4, 2012 (KR) 10-2012-0035155

(51) Int. Cl. H04N 5/232

(52) U.S. Cl. CPC H04N 5/23245
USPC 348/211.99

(57) ABSTRACT

A method and an apparatus for controlling an operation mode of a media device, and a recording medium for storing a program source of the method are provided. The method includes acquiring detection information according to a grasp of a user by at least one detector located on at least one side of the media device, determining whether the acquired detection information satisfies a set image capturing mode switching condition for switching to the image capturing mode, and switching to the image capturing mode when a result of the determination indicates that the acquired detection information satisfies the image capturing mode switching condition. Therefore, it is possible to simply and easily switch between operation modes by recognizing the grasp of a user.

### PRIORITY

This application claims the benefit under 35 U.S.C. §119(a) of a Korean patent application filed on Apr. 4, 2012 in the Korean Intellectual Property Office and assigned Serial No. 10-2012-0035155, the entire disclosure of which is hereby incorporated by reference.

### BACKGROUND OF THE INVENTION

1. Field of the Invention

The present invention relates to a method and an apparatus for controlling an operation mode of a media device. More particularly, the present invention relates to a method and an apparatus for switching to an image capturing mode according to the grasp of a media device by a user.

2. Description of the Related Art

Recently, various media devices, including a smart phone, are becoming more prevalent. These media devices have various functions including, for example, a phone call function, an audio reproduction function, a video reproduction function, a message transmission function, an image capturing function, and the like.

In such media devices, in order to switch to a mode for performing a particular function, a user must operate a keypad or a touch pad included in the media device. Accordingly, the user must search for a mode capable of performing the function desired by the user, and must instruct the media device to switch to the relevant mode. For example, while the user identifies a menu screen displayed by the media device, the user must search for and select an operation mode desired by the user. According to the related art as described above, the mode switching of the media device needs to go through a process of multiple key input steps, which causes an inconvenience to the user.

Meanwhile, media devices according to the related art may include hot keys in order to enable the media device to simply and easily switch between operation modes. A key value which causes the media device to switch to a particular operation mode is mapped to a corresponding hot key. When the user uses the hot key, a single key operation enables the media device to switch between operation modes. However, for media devices according to the related art that are equipped with hot keys to enable the device to switch between modes, there is an inconvenience in that the user must be well-acquainted with a hot key mapped to a particular operation mode.

Also, in order to enable a media device according to the related art to simply and easily switch between operation modes, the media device may include a key button related to switching to a particular mode at one side thereof. However, such a method for enabling the media device to simply and easily switch between operation modes has problems in that the method does not comport with a recent trend associated with a slimming of media devices. Further, such a method has design restrictions.

Therefore, a need exists for a system and method for simply and easily performing a particular function in an image capturing mode. Further, a need exists for a system and method for simply and easily switching to an image capturing mode in a media device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method capable of simply and easily controlling an operation mode in a media device.

Another aspect of the present invention is to provide a method capable of simply and easily switching to an image capturing mode in a media device.

Another aspect of the present invention is to provide a method capable of simply and easily performing a particular function in an image capturing mode.

Other aspects that the present invention is intended to provide can be understood from the following exemplary embodiments.

In accordance with an aspect of the present invention, a method for controlling an operation mode in order to switch to an image capturing mode in a media device is provided. The method includes acquiring detection information according to a grasp of a user by at least one detector located on at least one side of the media device, determining whether the acquired detection information satisfies a set image capturing mode switching condition for switching to the image capturing mode, and switching to the image capturing mode when a result of the determination indicates that the acquired detection information satisfies the image capturing mode switching condition.

In accordance with an aspect of the present invention, an apparatus for controlling an operation mode in order to switch to an image capturing mode in a media device is provided. The apparatus includes at least one detector, being located on at least one side of the media device, for acquiring detection information according to a grasp of a user, and a controller for determining whether the acquired detection information satisfies a set image capturing mode switching condition for switching to the image capturing mode, and for switching to the image capturing mode when a result of the determination indicates that the acquired detection information satisfies the image capturing mode switching condition.

In accordance with an aspect of the present invention, a method for controlling an operation mode in order to switch to an image capturing mode in a media device is provided. The method includes detecting, using at least one detector, characteristics associated with a way by which a user grasps the media device, determining whether the characteristics associated with the way by which the user grasps the media device corresponds to a condition for switching the media device to an image capturing mode, and switching the media device to the image capturing mode when the characteristics associated with the way by which the user grasps the media device corresponds to the condition for switching the device to an image capturing device.

In accordance with an aspect of the present invention, a processor-readable recording medium for recording a program for performing the method is provided. The processor-readable recording medium records a program for performing the method, which includes acquiring detection information according to a grasp of a user by at least one detector located on at least one side of the media device, determining whether the acquired detection information satisfies a set image capturing mode switching condition for switching to the image capturing mode, and switching to the image capturing mode when a result of the determination indicates that the acquired detection information satisfies the image capturing mode switching condition.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 is an illustrative view for explaining a detector of a media device according to an exemplary embodiment of the present invention;

FIG. 2 is a flowchart for explaining a method for switching to an image capturing mode according to an exemplary embodiment of the present invention;

FIG. 3 is a view showing an example of a screen requesting a user's response as to whether switching to an image capturing mode is to be performed, according to an exemplary embodiment of the present invention;

FIGS. 4A and 4B are illustrative views for explaining a method for performing a particular function in an image capturing mode according to an exemplary embodiment of the present invention;

FIG. 5 is an illustrative view for explaining a method for starting an image capturing function in an image capturing mode according to an exemplary embodiment of the present invention;

FIGS. 6A and 6B are illustrative views for explaining a method for performing a zoom-in function or a zoom-out function in an image capturing mode according to an exemplary embodiment of the present invention;

FIG. 7 is an illustrative view for explaining a method for using consecutive samples in switching to an image capturing mode according to an exemplary embodiment of the present invention; and

FIG. 8 is a block diagram showing the configuration of an apparatus for switching to an image capturing mode according to an exemplary embodiment of the present invention.

Throughout the drawings, it should be noted that like reference numbers are used to depict the same or similar elements, features, and structures.

### Detailed Description of Exemplary Embodiments

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As described above, the media device according to the related art has a problem in that in order to select a desired operation mode, the media device needs to go through a process of multiple key input steps or a user must be well-acquainted with a mapping relation that a particular key is assigned. Also, when the media device according to the related art includes a separate hardware-type button for a particular mode, the mobile device has a problem of causing a restriction in design.

Accordingly, exemplary embodiments of the present invention provide a method capable of simply and easily controlling an operation mode of a media device without causing a restriction in design. Particularly, exemplary embodiments of the present invention provide a method for switching to an image capturing mode according to the grasp of a media device by a user and a method for simply and easily performing a particular function after switching to the capturing mode.

According to an exemplary embodiment of the present invention, a media device recognizes the grasp of the media device by a user, and switches to an image capturing mode based on the recognized information. To this end, the media device according to an exemplary embodiment of the present invention includes, on at least one side thereof, at least one detector capable of detecting the grasp thereof by the user.

Also, according to an exemplary embodiment of the present invention, the media device first switches to the image capturing mode, and then performs a particular function in the image capturing mode based on detection information acquired by the at least one detector.

According to an exemplary embodiment of the present invention, the detector may include a first detector for recognizing a grasp of the user for switching to the image capturing mode, and a second detector for recognizing a grasp of the user for performing a particular operation in the image capturing mode user after the media device switches to the image capturing mode.

According to an exemplary embodiment of the present invention, the second detector may also be used to recognize the grasp of the user for switching to the image capturing mode, and the first detector may also be used to recognize the grasp of the user for performing the particular function in the image capturing mode.

In describing exemplary embodiments of the present invention, the term “detection information” is used to signify information acquired by at least one detector located on at least one side (which includes an outer part and an inner part of the media device) of the media device due to a grasp of the user. The detection information, for example, includes information on a part that the user comes into contact with, information on the number of times by which the user comes into contact with the media device during a time period which is set for the detector, and information on a degree by which the media device tilts due to the grasp of the media device by the user. The detection information may include at least one of capacitance information obtained by measuring a capacitance value, temperature information obtained by measuring a temperature, light amount information obtained by measuring the amount of light, and tilt information obtained by measuring a tilt.

In describing exemplary embodiments of the present invention, media devices which are devices capable of performing at least one of the recording, display and reproduction of media content, are used as a meaning including a mobile phone, a smart phone, a navigation, a Personal Digital Assistant (PDA), a Portable Multimedia Player (PMP), an Moving Picture Experts Group layer 3 (MP3) player, a game console, a tablet, a netbook, a desktop computer, a laptop computer, a communication terminal capable of Internet access, a communication terminal capable of receiving a broadcast signal, and the like.

In describing exemplary embodiments of the present invention, media which includes any information, is used as a meaning including text, audio data, an image, an animation, and video data.

Hereinafter, exemplary embodiments of the present invention will be described with reference to the accompanying drawings.

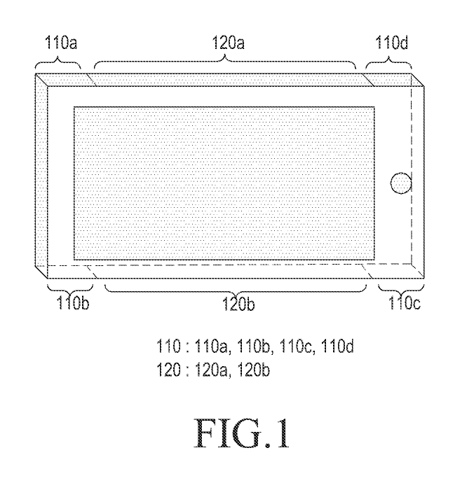

First, a detector according to an exemplary embodiment of the present invention will be described with reference to FIG. 1.

FIG. 1 is an illustrative view for explaining a detector of a media device according to an exemplary embodiment of the present invention.

Referring to FIG. 1, a media device according to an exemplary embodiment of the present invention includes a first detector 110. The first detector 110 includes at least one of detectors 110a, 110b, 110c and 110d, which are spaced apart from each other.

The first detector 110 acquires detection information used to switch to an image capturing mode. Namely, the media device switches to the image capturing mode based on detection information acquired by the first detector 110.

For example, it is assumed that a case of simultaneously grasping all of the detectors 110a, 110b, 110c and 110d is set as a condition for switching to the image capturing mode. At this time, when a user grasps all of the detectors 110a, 110b, 110c and 110d, the media device performs an operation for switching to the image capturing mode.

Also, after the media device switches to the image capturing mode, the first detector 110 acquires detection information used to perform a particular function in the image capturing mode. For example, in the image capturing mode, it is assumed that an image capturing function is set as a function corresponding to an instance in which the detector 110d is grasped. At this time, when the user grasps the detector 110d, the media device performs the image capturing function.

Meanwhile, according to an exemplary embodiment of the present invention, the media device may further include a second detector 120 distinguished from the first detector 110. The second detector 120 includes at least one of detectors 120a and 120b, which are spaced apart from each other.

The second detector 120 may be used to more reliably switch to the image capturing mode. For example, when the user grasps the whole part of the media device, or when the media device is located in a small storage space and thus, it is recognized that the whole part of the media device is being grasped, it is desirable that the media device does not switch between modes.

Accordingly, in an exemplary embodiment of the present invention, when the media device determines that it does not need to switch to the image capturing mode by using detection information acquired by the first detector 110 and the second detector 120, the media device may not switch between operation modes.

Also, after the media device switches to the image capturing mode, the second detector 120 may acquire detection information used to perform a particular function in the image capturing mode. For example, in the image capturing mode, when the detector 120a or the detector 120b recognizes a swipe action on the detector 120a or the detector 120b by the user, the media device may perform a zoom-in function or a zoom-out function according to the direction of the swipe. When the image capturing mode is a video image capturing mode capable of recording a moving image and voice, the media device may perform a volume-up function or a volume-down function according to the direction of the swipe.

Meanwhile, the number of detectors and positions thereof, which belong to each of the first detector 110 and the second detector 120, may be variously changed.

Hereinabove, the detector according to an exemplary embodiment of the present invention has been described with reference to FIG. 1. Hereinafter, a method in which the media device according to an exemplary embodiment of the present invention switches between operation modes by using detection information acquired by the detector, will be described in more detail with reference to the related drawings.

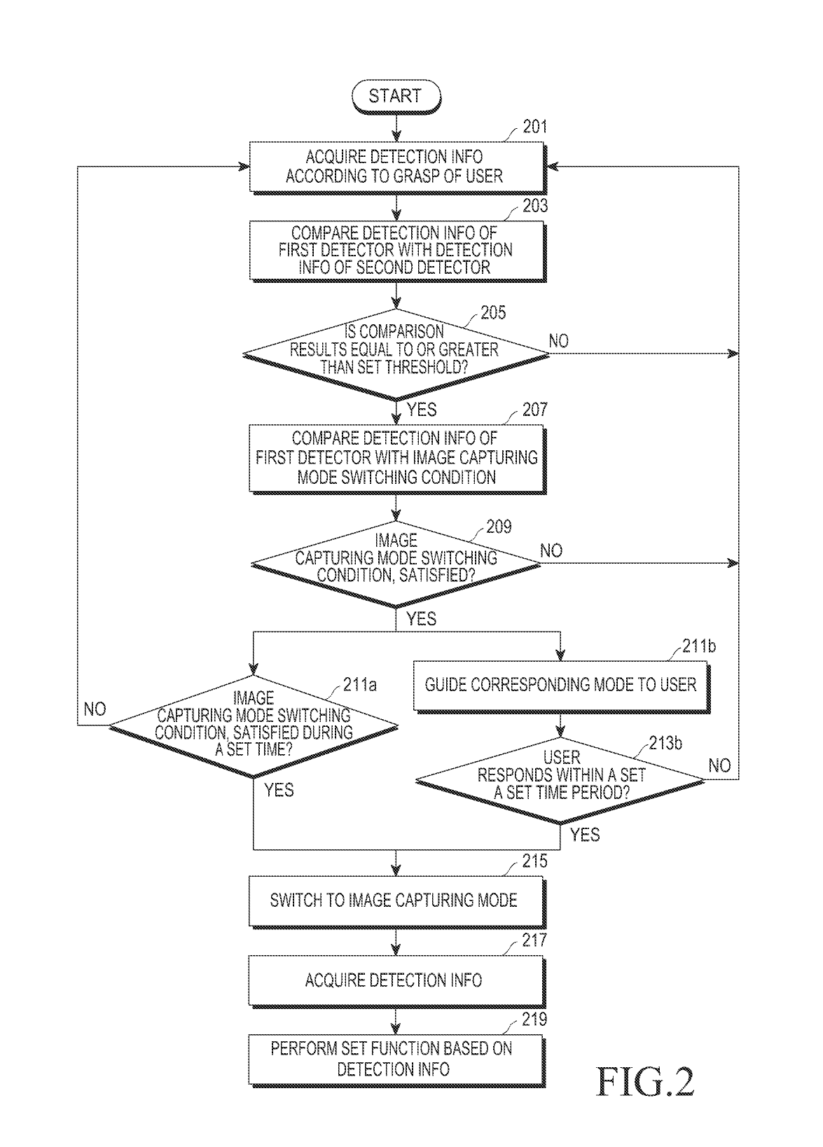

FIG. 2 is a flowchart for explaining a method for switching to an image capturing mode according to an exemplary embodiment of the present invention. Hereinafter, a method for switching to an image capturing mode according to an exemplary embodiment of the present invention will be described in detail with reference to FIG. 2. Some steps which will be described below with reference to FIG. 2 may be omitted.

Referring to FIG. 2, in step 201, the media device acquires detection information according to the grasp of the media device by a user.

Thereafter, the media device determines whether the acquired detection information satisfies a set image capturing mode switching condition for switching to the image capturing mode. When the image capturing mode switching condition is satisfied, the media device switches to the image capturing mode. In this regard, as described above, a case in which the user grasps the whole part of the media device or a case in which the media device is located in a small storage space, does not correspond to a case in which the media device is required to switch to the image capturing mode. Accordingly, in this case, the determination as to whether the detection information satisfies the image capturing mode switching condition may become a waste of a process, which is unnecessary.

Accordingly, an exemplary embodiment of the present invention determines in advance whether the acquired detection information requires switching to the image capturing mode, so that the occurrence of an unnecessary process is prevented. Such a process is illustrated in step 203 to step 205. According to an exemplary embodiment of the present invention, step 203 and step 205 may be omitted.

In step 203, the media device first compares detection information acquired by the first detector 110 with detection information acquired by the second detector 120, and then proceeds to step 205.

In step 205, the media device determines whether a value according to a result of the comparison in step 203 is equal to or greater than a set threshold. When a result of the determination in step 205 indicates that the comparison result value is equal to or greater than the set threshold, the media device proceeds to step 207. Otherwise, the media device proceeds to step 201.

As an example, when the media device determines that the comparison result value is less than the set threshold, based on the result of comparing the detection information acquired by the first detector 110 with the detection information acquired by the second detector 120, the media device does not perform a subsequent operation for switching between modes. For example, when the user grasps the whole part of the media device, the detection information acquired by the first detector 110 is almost similar to the detection information acquired by the second detector 120. Accordingly, the value, which has been obtained from the result of comparing the detection information acquired by the first detector 110 with the detection information acquired by the second detector 120, is less than the set threshold. In this case, the media device does not perform a subsequent operation for switching between modes.

This configuration will be described below in an example of equations.

For example, when v is a vector representing a contact detection point located on a detector and S is the first detector 110, both the number n1 of contact points, each of which is a contact detection point at which the grasp of the media device by the user is recognized among contact detection points located on the first detector 110, and the number n0 of contact points, each of which is a contact detection point at which the grasp of the media device by the user is recognized among contact detection points located on the second detector 120, may be expressed by Equation (1) below.

n1=(the number of vs|v ∈ s) and

n0−(the number of vs|v ∈ s) Equation . . . (1)

Herein, μ signifies a weight.

According to Equation (1), when n1−μn0>0, the media device performs a subsequent operation for switching to an image capturing mode. Namely, the media device compares detection information acquired by the first detector 110 with detection information acquired by the second detector 120, and performs the subsequent operation for switching to the image capturing mode when a value according to a result of the comparison is equal to or greater than a set threshold.

Meanwhile, when the noise of a sensor must be considered in obtaining the value of n1 and that of n0, a Bayesian criterion may be used. As defined by Equation (2) below, when H0 is a hypothesis in the case in which the value, which has been obtained from the result of comparing the detection information acquired by the first detector 110 with the detection information acquired by the second detector 120, is equal to or greater than the set threshold, and when H1 is a hypothesis in a case where the comparison result value is less than the set threshold, then Equation (2) may be expressed as:

H₁: n1>μn₀

H₀: otherwise Equation . . . (2)

When the value of n1 is greater by a predetermined ratio or more than n0, the media device should switch to the image capturing mode. Accordingly, an error may be expressed by r=n1−μn0, and a Likelihood Ratio Test (LRT) may be expressed by Equation (3) below.

$$Λ ( R ) = \frac{{P}_{r \vert {H}_{1}} ( R \vert {H}_{1} )}{{P}_{r \vert {H}_{0}} ( R \vert {H}_{0} )} {≷}_{{H}_{0}}^{{H}_{1}} \frac{{P}_{0} ( {C}_{10} - {C}_{00} )}{{P}_{1} ( {C}_{01} - {C}_{11} )} \qquad Equation ( 3 )$$

Herein, each of P0 and P1 signifies a probability of the occurrence of a hypothesis, and C_ij signifies the cost of damage or risk which may be caused by a wrong determination.

Meanwhile, in step 207 to which the media device proceeds according the result of determining that the value, which has been obtained from the result of comparing the detection information acquired by the first detector 110 with the detection information acquired by the second detector 120, is equal to or greater than the set threshold in step 205, the media device first compares the detection information acquired by the first detector 110 with an image capturing mode switching condition for switching to the image capturing mode, and then proceeds to step 209.

In step 209, the media device determines whether a switching condition for an image capturing mode is satisfied. When a result of the determination in step 209 indicates that the detection information acquired by the first detector 110 satisfies the image capturing mode switching condition, the media device proceeds to step 211a or step 211b according to setting. In contrast, when the result of the determination in step 209 indicates that the detection information acquired by the first detector 110 does not satisfy the image capturing mode switching condition, the media device proceeds to step 201.

As described above, when the detection information acquired by the first detector 110 satisfies the image capturing mode switching condition, the media device may proceed to step 211a or step 211b according to the setting. In step 211a the media device switches to the image capturing mode without waiting for a response from the user when the detection information satisfies the image capturing mode switching condition. In contrast, in step 211b the media device waits for a response from the user and switches to the image capturing mode according to the response.

According to exemplary embodiments of the present invention, in step 211a, the media device determines whether the detection information satisfying the image capturing mode switching condition is continuously acquired during a set time period. Namely, when the detection information satisfying the image capturing mode switching condition is continuously acquired during the set time period, the media device proceeds to step 215, and switches to the image capturing mode.

According to exemplary embodiments of the present invention, in step 211b, the media device first outputs a guide message inquiring whether to switch to the image capturing mode, and then proceeds to step 213b. The guide message may be output as characters or as an image on a screen, may be output through a lamp or the like included in the media device, may be output as voice, and/or the like.

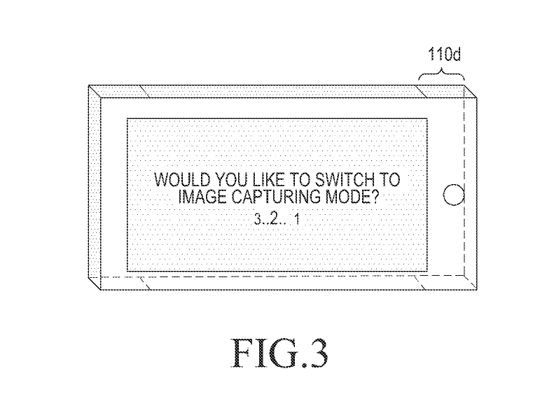

Thereafter, in step 213b, when the user responds to the guide message within a set time period, the media device proceeds to step 215. In step 215, the media device switches to the image capturing mode. In contrast, when the user does not respond to the guide message within the set time period, the media device proceeds to step 201. Step 211b and step 213b will be described below with reference to FIG. 3.

FIG. 3 is a view showing an example of a screen requesting a user's response as to whether switching to an image capturing mode is to be performed, according to an exemplary embodiment of the present invention.

Referring to FIG. 3, the media device may output, on a screen thereof, a guide message inquiring whether to switch to the image capturing mode. For example, when the user does not respond to the message within 3 seconds after the media device outputs a message asking “Would you like to switch to an image capturing mode?” on the screen, the media device may not switch to the image capturing mode. In contrast, when the user responds to the message through the first detector 110d within 3 seconds, the media device may switch to the image capturing mode. Meanwhile, while the media device waits for the response of the user as described above, the media device may hierarchically display the guide message on the screen which is originally being used for the task. For example, the message may be displayed on a screen having a higher opacity than the screen which was being used for the task.

Meanwhile, in the above description of step 213b, a case has been shown and described in an example in which the media device switches to the relevant image capturing mode when the user responds to the guide message within the set time period. However, even when the user does not respond to the guide message within the set time period, the media device may be configured to switch to the image capturing mode.

Referring back to FIG. 2, when the media device proceeds to step 215 and switches to the image capturing mode, the media device may notify the user that the media device has switched to the image capturing mode. The notification may be output as characters or as an image on the screen, may be output through a lamp or the like included in the media device, may be output as voice, and/or the like.

After the media device switches to the image capturing mode in step 201 to step 215, the media device performs a particular set function based on detection information acquired by at least one of the first detector 110 and the second detector 120. This configuration is shown in step 217 and step 219. According to an exemplary embodiment of the present invention, step 217 and step 219 may be omitted.

In step 217, the media device acquires detection information. For example, the media device may acquire the detection information through at least one of the first detector 110 and the second detector 120. When detection information is acquired by at least one of the first detector 110 and the second detector 120 in step 517, the media device proceeds to step 219. The detection information acquired in step 217 may be, for example, information on the number of times of contact or information on a change in a contact position.

In step 219, the media device performs the particular set function based on the detection information acquired in step 217. For example, when the detection information acquired by the first detector 110 and the second detector 120 is matched to a condition for executing the particular function in the image capturing mode, the media device performs the relevant particular function. For example, the media device may perform various functions, such as the start of image capturing, zoom-in, zoom-out, volume-up, volume-down, and the like.

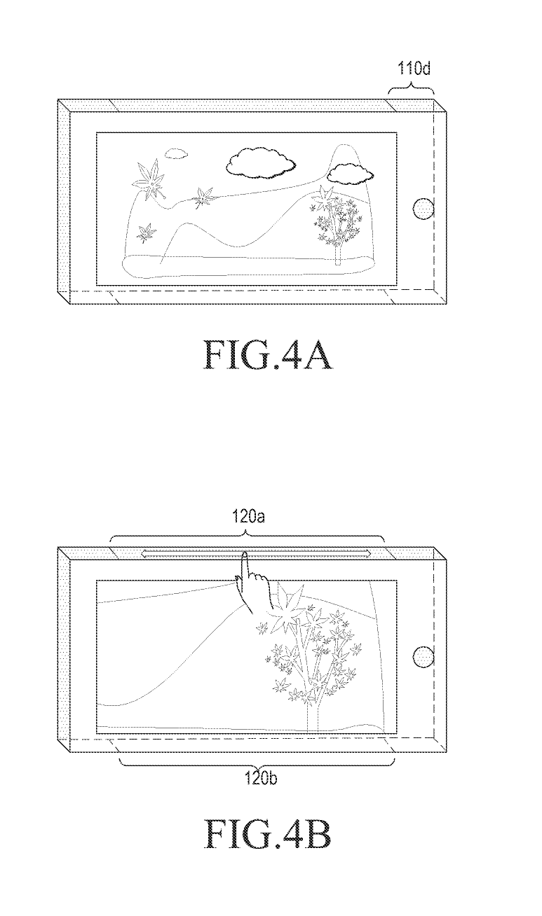

The execution of the particular function in the image capturing mode will be described below with reference to FIGS. 4A and 4B.

FIGS. 4A and 4B are illustrative views for explaining a method for performing a particular function in an image capturing mode according to an exemplary embodiment of the present invention.

Referring to FIGS. 4A and 4B, in the image capturing mode, when the media device recognizes an action of swiping the detector 110d by the user as shown in FIG. 4A, the media device may perform an image capturing function. When the media device recognizes a swipe action on the detector 120a as shown in FIG. 4B, the media device may perform a zoom-in function or a zoom-out function. Otherwise, for example, when the media device recognizes a swipe action on the detector 120b, the media device may perform a volume-up function or a volume-down function.

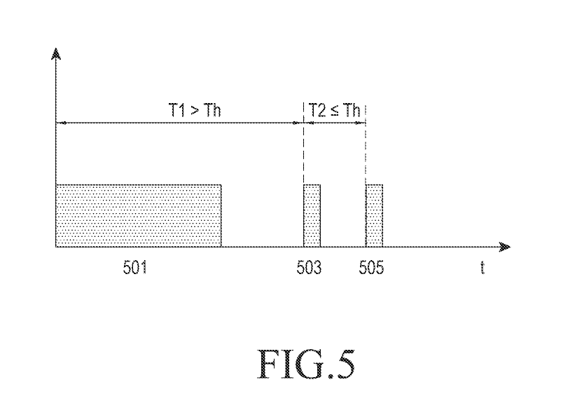

Meanwhile, in performing the image capturing function, when a time interval of a contact event of the user is within a set threshold, it may be determined that the media device starts the image capturing function. The start of the image capturing function will be described below with reference to FIG. 5.

FIG. 5 is an illustrative view for explaining a method for starting an image capturing function in an image capturing mode according to an exemplary embodiment of the present invention.

In FIG. 5, reference numerals 501, 503 and 505 denote contact events of the user, and Th represents a set threshold.

Referring to FIG. 5, a time interval T1 between a start point of a first contact event 501 and a start point of a second contact event 503 is greater than a set threshold Th, and thus is not recognized as the start of the image capturing function. In contrast, a time interval T2 between a start point of a second contact event 503 and a start point of a third contact event 505 is equal to or less than a set threshold Th, and thus is recognized as the start of the image capturing function.

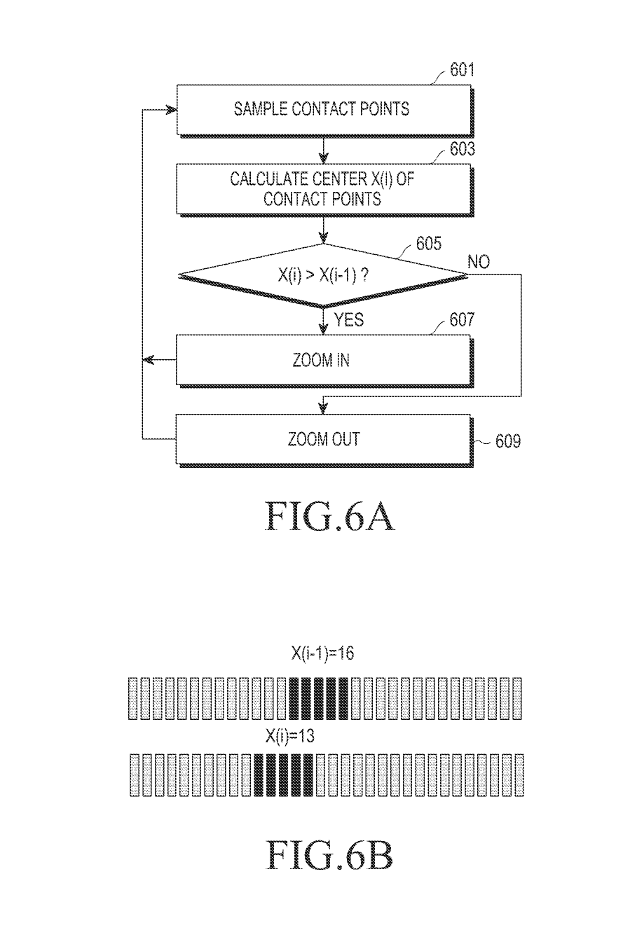

Meanwhile, a zoom-in function or a zoom-out function may be performed by tracing the center of a contact point at which a contact of the user is detected. This configuration will be described below with reference to FIGS. 6A and 6B.

FIGS. 6A and 6B are illustrative views for explaining a method for performing a zoom-in function or a zoom-out function in an image capturing mode according to an exemplary embodiment of the present invention.

Referring to FIG. 6A, in step 601, the media device first samples contact points at which the second detector 120a recognizes the grasp of the media device by the user, and then proceeds to step 603.

In step 603, the media device calculates center coordinates X(i) of the sampled contact points, and then proceeds to step 605.

In step 605, the media device compares the center coordinates X(i) of the currently sampled contact points with center coordinates X(i−1) of the previously sampled contact points. According to a result of the comparison, the media device proceeds to step 607 or step 609, and performs a zoom-in function or a zoom-out function. For example, if center coordinates X(i) are greater than center coordinates X(i−1), then the media device proceeds to step 607 in which the media device performs a zoom-in function. In contrast, if center coordinates X(i) are not greater than center coordinates X(i−1), then the media device proceeds to step 609 in which the media device performs a zoom-out function.

This configuration will be described below with reference to FIG. 6B illustrating contact points located on the second detector 120a.

Referring to FIG. 6B, for example, when it is assumed that a center coordinate X(i−1) of the previously sampled contact points is 16 and a center coordinate X(i) of the currently sampled contact points is 13, X(i)=13<X(i−1)=16. Accordingly, the media device proceeds to step 609, and performs the zoom-out function.

In contrast, when it is assumed that a center coordinate X(i−1) of the previously sampled contact points is 13 and a center coordinate X(i) of the currently sampled contact points is 16, X(i)=16>X(i−1)=13. Accordingly, the media device proceeds to step 607, and performs the zoom-in function.

Meanwhile, in the description of step 211a and step 215 as shown in FIG. 2, a case of switching to the image capturing mode has been described as an example in which the detection information satisfying the image capturing mode switching condition is acquired during the set time period or more. However, according to another exemplary embodiment of the present invention, there may be a method for using consecutive samples.

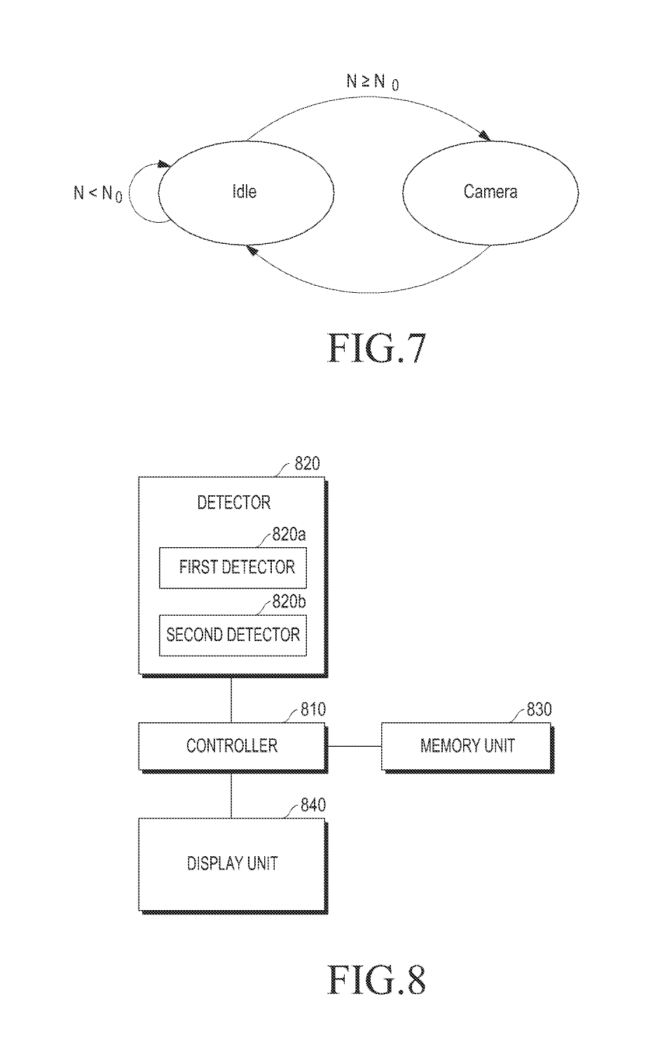

FIG. 7 is an illustrative view for explaining a method for using consecutive samples in switching to an image capturing mode according to an exemplary embodiment of the present invention.

Referring to FIG. 7, the position of grasp of the user, namely, the position of the user's fingers which come into contact with the media device continuously changes. Accordingly, only one sampling makes it difficult to clearly determine whether a request is made for switching to the image capturing mode. Accordingly, when an N number of consecutive samples are acquired and N representing the number of the acquired consecutive samples is equal to or greater than a set threshold N0, the media device may switch to the image capturing mode.

FIG. 7, a state transition diagram showing that the media device maintains an idle mode when the number N of acquired consecutive samples is less than the threshold N0 whereas the media device switches to the image capturing mode when the number N of acquired consecutive samples is equal to or greater than the threshold N0. Such an operation may be performed even in a locked state of the media device.

Meanwhile, according to an exemplary embodiment of the present invention, in order to perform the operation of step 217 and that of step 219, the media device maintains the image capturing mode until a particular set signal is input. For example, after the user simultaneously grasps all of the detectors 110a, 110b, 110c and 110d included in the first detector and the media device switches to the image capturing mode, the media device maintains the image capturing mode even when the user stops grasping any one (for example, the detector 110d ) of the detectors 110a, 110b, 110c and 110d included in the first detector,. Meanwhile, a particular signal for terminating the image capturing mode may be generated by the selection of a particular menu displayed on the screen. Otherwise, the particular signal for terminating the image capturing mode may be generated by an action of grasping the detector by the user, for example, an action such that the user grasps the detector 110d three times in a row within a set time period.

Hereinabove, the method for switching to an image capturing mode according to an exemplary embodiment of the present invention has been described with reference to FIGS. 2 to 7. Hereinafter, an apparatus for switching to an image capturing mode according to an exemplary embodiment of the present invention will be described with reference to FIG. 8.

FIG. 8 is a block diagram showing the configuration of an apparatus for switching to an image capturing mode according to an exemplary embodiment of the present invention.

Referring to FIG. 8, an apparatus for switching to an image capturing mode according to an embodiment of the present invention includes a controller 810, a detector 820, a memory unit 830, and a display unit 840.

The controller 810 compares detection information acquired by the detector 820 with a set image capturing mode switching condition, and causes the media device to switch to the image capturing mode when the detection information satisfies the image capturing mode switching condition.

According to an exemplary embodiment of the present invention, in order to prevent the occurrence of an unnecessary process, the controller 810 may determine whether the user makes a request for switching to the image capturing mode, based on the detection information acquired by the detector 820. Namely, the controller 810 compares detection information acquired by a first detector 820a with detection information acquired by a second detector 820b. When a value according to a result of the comparison is less than a set threshold, the controller 810 may not cause the mobile device to switch between modes. Meanwhile, when the value according to the result of the comparison is equal to or greater than the set threshold, the controller 810 determines whether the detection information acquired by the first detector 810a satisfies the image capturing mode switching condition. When the detection information satisfies the image capturing mode switching condition, the controller 810 may perform a series of processes for switching to the image capturing mode.

According to an exemplary embodiment of the present invention, in order to more reliably switch between modes in switching to the image capturing mode, the controller 810 may cause the media device to switch to the image capturing mode when the detection information acquired by the first detector 820a satisfies the image capturing mode switching condition during a set time period or more. Namely, the controller 810 may cause the media device to switch to the image capturing mode when the detection information satisfying the image capturing mode switching condition is acquired during the set time period or more.

According to an exemplary embodiment of the present invention, in switching to the image capturing mode, the controller 810 may request a user's response as to whether switching to the image capturing mode is to be performed. For example, the controller 810 may output a message reporting that the acquired detection information satisfies the image capturing mode switching condition, as voice through a speaker (not shown). Otherwise, the controller 810 may output the message as an image through the display unit 840. When the user responds to the message within a set time period, according to a setting, the controller 810 may cause the media device to switch to the image capturing mode, or may not cause the media device to switch to the image capturing mode. Similarly, when the user does not respond to the message within the set time period, according to a setting, the controller 810 may cause the media device to switch to the image capturing mode, or may not cause the media device to switch to the image capturing mode.

After the controller 810 causes the media device to switch to the image capturing mode, the controller 810 may maintain the relevant operation mode until a particular set signal is input.

Meanwhile, after the controller 810 causes the media device to switch to the image capturing mode, the controller 810 may perform a particular function in the image capturing mode based on acquired detection information. For example, after the controller 810 causes the media device to switch to the image capturing mode, the controller 810 may perform any one of functions such as zoom-in, zoom-out, volume-up and volume-down, and the like, based on acquired detection information.

The detector 820 acquires at least one piece of detection information according to the grasp of the media device by the user, and includes the first detector 820a and the second detector 820b. The first detector 820a corresponds to the first detector 110 as shown in FIG. 1, and the second detector 820b corresponds to the second detector 120 as shown in FIG. 1. The detector 820 may include at least one of a capacitance sensor, a temperature sensor, a piezoelectric sensor, an optical sensor, a tilt sensor, and the like. Meanwhile, in FIG. 1, the detectors 110 and 120 are located only on an outer lateral surface of the media device. However, the detectors 110 and 120 may be located within the media device. For example, the tilt sensor may be located within the media device. In this case, the controller 810 may further use tilt information of the media device to determine whether switching to the image capturing mode is to be performed. Namely, based on whether the media device tilts at a set reference angle or more, the controller 810 may determine whether switching to an image capturing mode is to be performed.

Meanwhile, the detector 820 may deliver the detected information to the controller 810, as it is. Otherwise, the detector 820 may deliver a result of analyzing the detected information to the controller 810. When a case is described as an example in which the media device recognizes an action of swiping the detector 820 by the user, the detector 820 may acquire information on a contact position of the user at every set time point, and may deliver the acquired information to the controller 810. Then, the controller 810 may collect the multiple pieces of information delivered by the detector 820, and may recognize that the swipe action has been performed, based on the collected information. Otherwise, the detector 820 itself may first calculate a change in a contact position of the user, and may then deliver information reporting that the swipe action has been recognized, to the controller 810.

The memory unit 830 stores an image capturing mode switching condition for switching to the image capturing mode. For example, the memory unit 830 stores information on which part of the media device is grasped in a case in which the media device switches to the image capturing mode. Also, according to an embodiment, the memory unit 830 may further store information on how long and which part of the media device is grasped in a case where the media device switches to the image capturing mode.

The display unit 840 outputs various images during operations according to an exemplary embodiment of the present invention. For example, the display unit 840 outputs a guide message requesting a user's response to whether switching to an image capturing mode is to be performed.

As described above, the method in which the media device switches to the image capturing mode according to the grasp of the media device by the user and the particular function is performed in the switched image capturing mode, has been described and shown with reference to the accompanying drawings. However, exemplary embodiments of the present invention are not limited to the image capturing mode.

Exemplary embodiments of the present invention may be applied to all methods each for switching between operation modes according to the grasp of a media device by a user. For example, exemplary embodiments of the present invention may be used to switch to an e-book mode for displaying text of an e-book or the like, a moving image mode for displaying a moving image or the like, a game mode for executing a game, and the like.

The exemplary embodiments of the present invention as described above may be implemented by various optional methods. For example, the exemplary embodiments of the present invention may be implemented in hardware, in software, or in a combination of hardware and software. When the exemplary embodiments of the present invention are implemented in software, the exemplary embodiments of the present invention may be implemented in software executed by one or more processors using various operating systems or various platforms. In addition, this software may be written by using an optional programming language among multiple appropriate programming languages. Also, this software may be compiled into an executable machine language code or intermediate code, which is executed by a framework or a virtual machine.

Also, when the exemplary embodiments of the present invention are executed by one or more processors, the exemplary embodiments of the present invention may be implemented by using non-transitory processor-readable mediums (for example, a memory, a floppy disk, a compact disk, an optical disk, a magnetic tape, and the like) for recording one or more programs for performing the methods which implements the various exemplary embodiments of the present invention as discussed above.

As described above, the present invention has an advantage in that it is possible to simply and easily switch between operation modes by recognizing the grasp of a user.

Also, the present invention has an advantage in that it is possible to simply and easily perform a desired function by recognizing the grasp of a user.

While the invention has been shown and described with reference to certain exemplary embodiments thereof, it will be understood by those skilled in the art that various changes in form and details may be made therein without departing from the spirit and scope of the present invention as defined by the appended claims and equivalents thereof.

What is claimed is:

1. A method for controlling an operation mode in order to switch to an image capturing mode in a media device, the method comprising:
acquiring detection information according to a grasp of a user by at least one detector located on at least one side of the media device;
determining whether the acquired detection information satisfies a set image capturing mode switching condition for switching to the image capturing mode; and
switching to the image capturing mode when a result of the determination indicates that the acquired detection information satisfies the image capturing mode switching condition.

2. The method of claim 1, wherein the determining as to whether the acquired detection information satisfies the set image capturing mode switching condition comprises determining whether the detection information satisfies the image capturing mode switching condition during a set time period or more.

3. The method of claim 1, further comprising, before the switching to the image capturing mode, requesting a user's response as to whether switching to the image capturing mode is to be performed.

4. The method of claim 3, wherein the switching to the image capturing mode comprises switching to the image capturing mode when the user's response requesting switching to the image capturing mode is received within a set time period.

5. The method of claim 1, wherein the determining as to whether the acquired detection information satisfies the set image capturing mode switching condition comprises:
comparing detection information acquired by a first detector of the at least one detector with detection information acquired by a second detector of the at least one detector; and
determining whether the image capturing mode switching condition is satisfied when a value according to a result of the comparison is equal to or greater than a set threshold.

6. The method of claim 1, further comprising, after switching to the image capturing mode, maintaining the image capturing mode until a set signal is input.

7. The method of claim 6, further comprising, after maintaining the image capturing mode, performing an image capturing function based on detection information acquired by a first detector of the at least one detector.

8. The method of claim 6, further comprising, after maintaining the image capturing mode, performing at least one of a zoom-in function, a zoom-out function, a volume-up function, and a volume-down function based on detection information acquired by a second detector of the at least one detector.

9. An apparatus for controlling an operation mode in order to switch to an image capturing mode in a media device, the apparatus comprising:
at least one detector, being located on at least one side of the media device, for acquiring detection information according to a grasp of a user; and
a controller for determining whether the acquired detection information satisfies a set image capturing mode switching condition for switching to the image capturing mode, and for switching to the image capturing mode when a result of the determination indicates that the acquired detection information satisfies the image capturing mode switching condition.

10. The apparatus of claim 9, wherein the controller is configured to determine whether the detection information satisfies the image capturing mode switching condition during a set time period or more.

11. The apparatus of claim 9, wherein the controller is configured to generate and output a signal requesting a user's response as to whether switching to the image capturing mode is to be performed.

12. The apparatus of claim 11, wherein the controller is configured to switch to the image capturing mode when the user's response requesting switching to the image capturing mode is received within a set time period.

13. The apparatus of claim 9, wherein the controller is configured to compare detection information acquired by a first detector of the at least one detector with detection information acquired by a second detector of the at least one detector, and to determine whether the image capturing mode switching condition is satisfied when a value according to a result of the comparison is equal to or greater than a set threshold.

14. The apparatus of claim 9, wherein the controller is configured to maintain the image capturing mode until a set signal is input.

15. The apparatus of claim 14, wherein the controller is configured to perform an image capturing function based on detection information acquired by a first detector of the at least one detector while maintaining the image capturing mode.

16. The apparatus of claim 14, wherein the controller is configured to perform a zoom-in function or a zoom-out function based on detection information acquired by a second detector of the at least one detector while maintaining the image capturing mode.

17. A method for controlling an operation mode in order to switch to an image capturing mode in a media device, the method comprising:
detecting, using at least one detector, characteristics associated with a way by which a user grasps the media device;
determining whether the characteristics associated with the way by which the user grasps the media device corresponds to a condition for switching the media device to an image capturing mode; and
switching the media device to the image capturing mode when the characteristics associated with the way by which the user grasps the media device corresponds to the condition for switching the device to an image capturing device.

18. The method of claim 17, further comprising:
requesting confirmation from the user that the media device is to be switched to the image capturing mode.

19. The method of claim 17, wherein the determining as to whether the characteristics associated with the way by which the user grasps the media device corresponds to a condition for switching the media device to an image capturing mode comprises:
comparing detection information acquired by a first detector of the at least one detector with detection information acquired by a second detector of the at least one detector; and
determining whether the image capturing mode switching condition is satisfied when a value according to a result of the comparison is equal to or greater than a set threshold.
